(19) United States
(12) Patent Application Publication
(10) Pub. No.: US 2005/0114378 A1
(43) Pub. Date: May 26, 2005

(54) System and method for providing a standardized adaptor framework

(75) Inventors: Jean-Emile Elien, Bellevue, WA (US); Neilton Jared Saari, Seattle, WA (US); Rammohan Nagasubramani, Sammamish, WA (US); Kartik Paramasivam, Redmond, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/721,002

(22) Filed: Nov. 24, 2003

(51) Int. Cl. G06F 17/00

(52) U.S. Cl. 707/102

(57) ABSTRACT

A standardized framework for adaptors is provided by a configuration user interface module that receives configuration descriptive data in a hierarchical file format and a metadata utility that receives communication format data in a hierarchical file format. An adaptor-specific interface is generated from the configuration descriptive data may collect instance-specific configuration information. The information is stored as an XML file.

### FIELD OF THE INVENTION

The invention relates to software integration and in particular to providing a standardized framework in which to communicate between different software systems.

### BACKGROUND OF THE INVENTION

An integration server or connector is a mechanism such as a computer server, which is used to facilitate interaction between different operating systems and applications across internal and external networked computer systems. A typical integration server environment is illustrated in FIG. 2.

Typically, an integration server facilitates interactions between different Line-of-Business applications by exposing the functionality of one Line-of-Business application to another Line-of-Business application, to a client application or to an application integration platform. A Line-of-Business application is an enterprise application that provides departmental or functional capabilities that may be used by a department or facility of an enterprise or by the entire enterprise. Prefabricated Line-of-Business applications such as SAP, Siebel, PeopleSoft, and Mumps, customized Line-of-Business applications and legacy Line-of-Business applications are common.

An enterprise integration server such as integration server 260 may also facilitate communication between databases, and may facilitate the use of different transport protocols. Exemplary databases accessed may be Microsoft SQL Server, DB2 and Oracle. Exemplary transport protocols used may be HTTP, FTP, MQSeries and TCP-IP.

A corporation, for example, may have their client base (customer) information in one software system (e.g., application 1 202) and their Human Resources data in another (e.g., application 2 204). In order to retrieve and integrate data from both systems, the two systems must be connected. The integration server 260 provides the pipeline infrastructure to connect the two systems. Enterprise software 270 combines and processes the information from the different software.

An adaptor is a software component that abstracts out specifics associated with a particular application, database or protocol from the integration server. The adapter helps the Line-of-Business application to “adapt” to another Line-of-Business by enabling it to use communications protocols and semantic interactions that the Line-of-Business application understands.

There are three broad categories of adaptors: adaptors such as adaptors 242 and 244, that interface with applications, such as application 202 and 204. Application adapters typically include protocol conversion, procedural semantics and abstract application level interactions with the (Line-of-Business) application. A second type of adaptor (e.g., adaptor 3 246 and adaptor 4 248) interface with and access databases using database style parameters and results, (e.g., database 1 206 and database 2 208). Protocol or transport-oriented adaptors, (e.g., adaptor 5 250 and adaptor 6 252), are adaptors that abstract transport specifics from transport protocols 210, 212 and are primarily focused on protocol handling.

Typically, each adaptor has its own integrated applications (user interfaces) for configuration, management and setup, making it necessary for users of adapters to learn and use multiple user interfaces for each adapter. For example, in typical enterprise application integration (EAI) deployment using seven adapters to various systems, the data center operator could be faced with training his staff on seven different applications for configuration and seven different applications for management. For example, in the exemplary system of FIG. 2, user interface 1 222/adapter 1 242 interfaces with application 1 202, user interface 2 224/adapter 2 244 interfaces with application 2 204, user interface 3 226/adaptor 3 246 interfaces with database 1 206, user interface 4 228/adaptor 4 248 interfaces with database 2 208, user interface 5 230/adapter 5 250 interfaces with transport protocol 1 210, and user interface 6 232/adapter 6 252 interfaces with transport protocol 2 212. This configuration requires a developer to write and test code for each user interface, 222, 224, 226, 228, 230, 232, and for each adaptor 242, 244, 246 248, 250 and 252, a significant development burden. A user 280 is required to learn how to use the particular user interface employed by the application he wishes to access in order to select information of interest and to control the adaptor.

Issue resolution and maintenance in such a scenario is likely to be a nightmare. As the number of connectors increases and the issues addressed by connectors increases a need for a prescriptive way to develop connectors arises and a common framework to build connectors becomes more and more important.

It would be helpful if there were a connector framework that would ease installation, configuration, management and operations of connectors. A standardized user interface for all adaptors would be helpful so that a user would only have to learn a single user interface that could be used with all adaptors. It would also be helpful, if the user interface could be automatically generated through automated discovery, centralized configuration and machine useable description of configuration, interaction patterns, methods, events and message formats.

### SUMMARY OF THE INVENTION

A system, method and computer-readable medium containing computer-executable instructions provides a framework to enable software applications like servers to support protocols, data access (e.g., access to databases) and enterprise application connectivity. The framework may provide application level interoperability between software applications using Web Services standards. An XML-based representation method of description (e.g., XML schema or WSDL) may be used. A unified user interface may be generated from the XML schema and configuration data stored in an XML file.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of a system for providing connectivity as described in the BACKGROUND section;

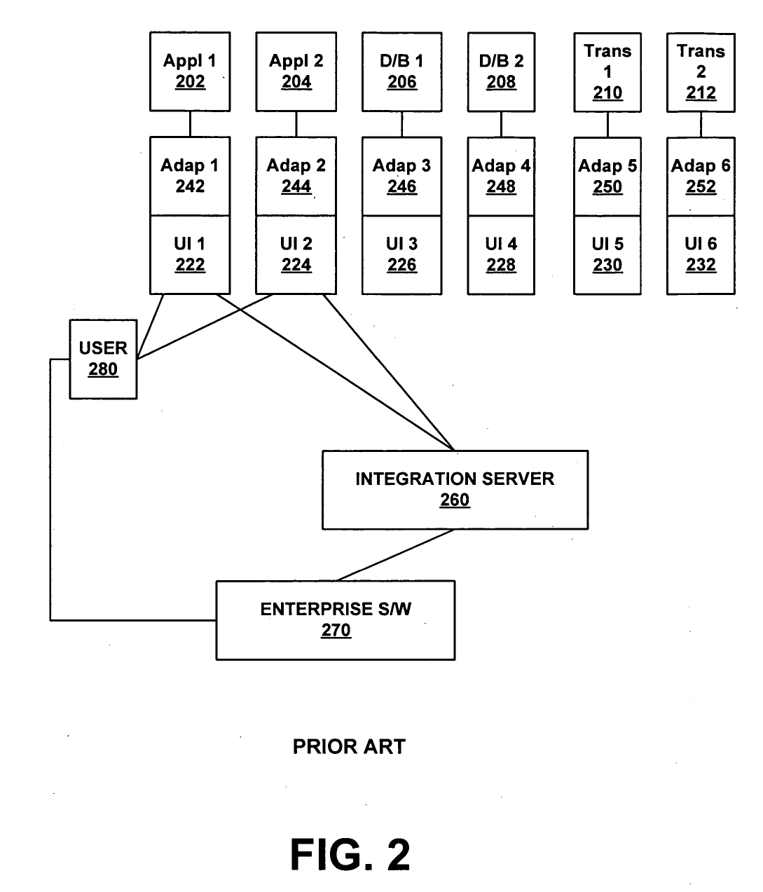

FIG. 3 is a block diagram of an exemplary system in which the invention may be implemented;

FIG. 4 is a block diagram of an exemplary system for providing a standardized adaptor framework in accordance with one embodiment of the invention;

FIG. 5 is a flow diagram of a method of providing a standardized adaptor framework in accordance with one embodiment of the invention;

### DETAILED DESCRIPTION OF ILLUSTRATIVE EMBODIMENTS

Overview

A system, method and computer-readable medium containing computer-executable instructions provides a framework to enable software applications like servers to support protocols, data access and enterprise application connectivity. The framework may provide application level interoperability between software applications using Web Services standards.

Exemplary Computing Environment

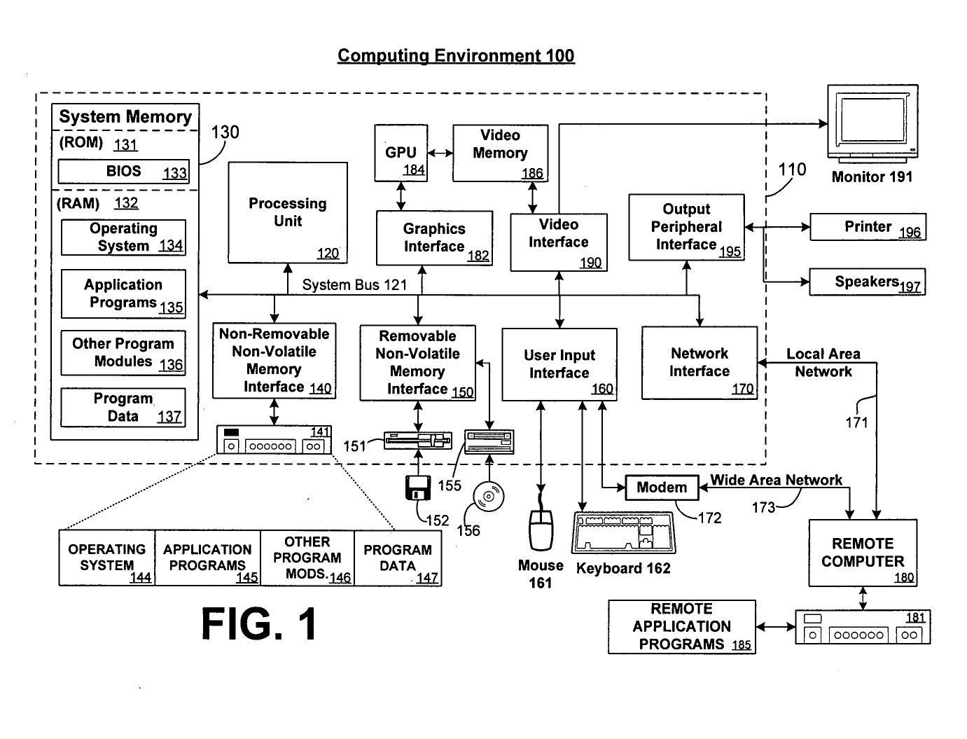

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

System and Method for Providing a Standardized Adaptor Framework

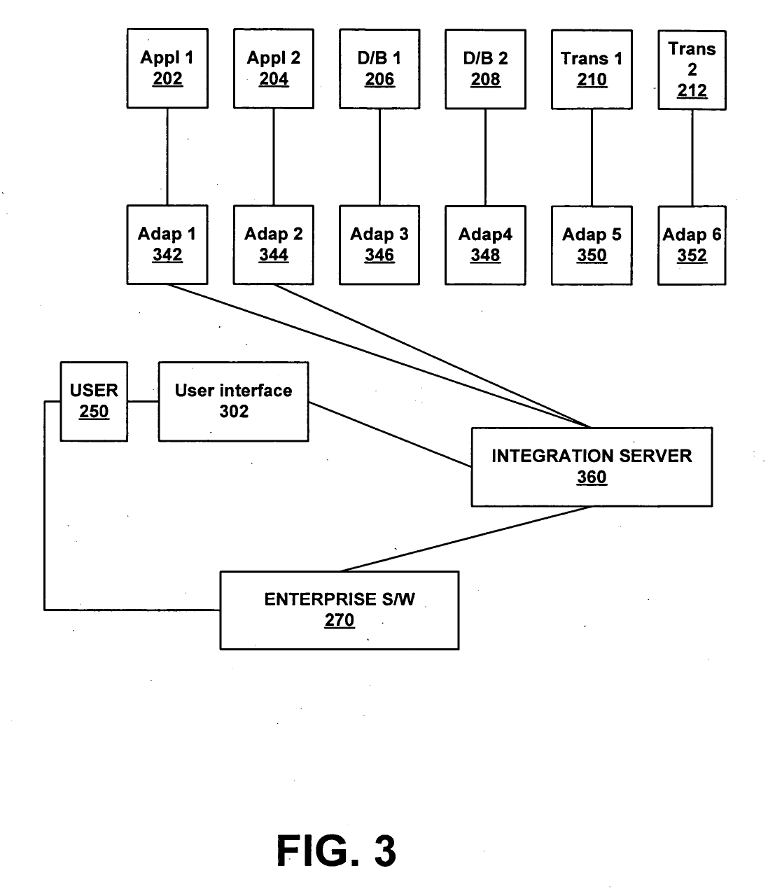

FIG. 3 illustrates an exemplary environment in which the invention may be implemented in accordance with one embodiment of the invention. In FIG. 3, a single user interface 302 generated by integration server 360 interfaces with all the different software systems, 202, 204, 206, 208, 210, 212 via adaptors 342, 244, 246, 248, 350 and 352.

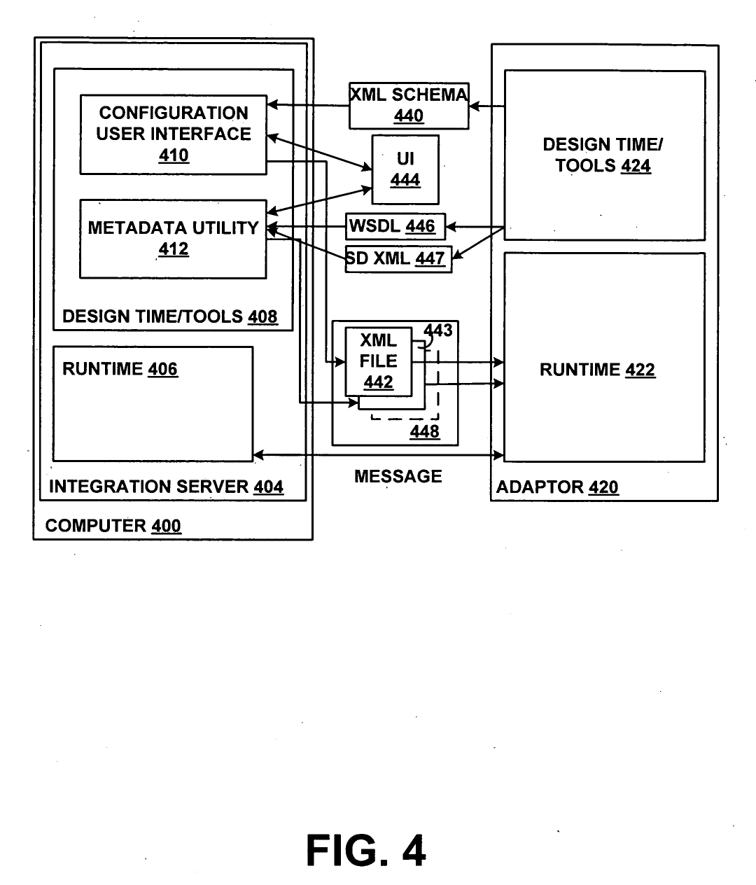

FIG. 4 illustrates a system for providing an adaptor framework in accordance with one embodiment of the invention. Referring now to FIG. 4, computer 400 represents a computer such as the one described with respect to FIG. 1, on which the invention may reside.

In respective embodiments of the invention, an integration server 404 may include one of or both a design time/tools component 408 and a runtime engine 406. The design time/tools component 408 may comprise one of or both a configuration user interface module 410 and a metadata utility 412. In some embodiments of the invention, the configuration user interface module 410 and metadata utility 412 are components that interface with adaptor 420.

Adaptor 420 may include one of or both a design time/tools component 424 and a runtime engine 422.

In one embodiment of the invention, the configuration user interface 410 receives an XML schema 440 from the design time/tools component 424 of adaptor 420. The configuration user interface 410 in one embodiment of the invention displays a unified user interface 444 to acquire use input and generates an XML file 442 containing user input. The XML file 442 is used by the adaptor runtime 422 to configure the selected service for accepting or transmitting messages. The user interface 444 may be used to obtain user specified configuration values, such as server name, IP address, login and password. The additional user-specified information is saved in the XML file 442. The XML file 442 may identify to the adaptor information including one or more of the following properties: the server to be connected to, the application to be used, the logon to connect to the server, the password to connect to the server and similar information, or any other information needed by the adapter or application to run correctly. The configuration user interface 410 may create a number of XML files 442, 443, etc. each file corresponding to a particular use of the adaptor such as exemplary adaptor 420 and may store the XML files 442, 443, etc. in a library of XML files 448. The library of files 448 may be implemented as a configuration database or other suitable data store. The configuration data store holds configuration information associated with adapters and connectors including but not limited to descriptive information associated with configuration, enumeration and description of capabilities, description of interactions, description of messages, etc. The data store may also store custom properties required by the connector.

Similarly, in one embodiment of the invention, the metadata utility 412 of the integration server 404 receives one or more WSDL files and associated XML schema files from the design time/tools component 424 of adaptor 420. The WSDL file(s) may provide the adaptor's service description (interfaces) and type information for the data that flows in and out of the adaptor and may be accompanied by associated XML schema files. The metadata utility 412 in one embodiment of the invention displays a unified interface 444 from the WSDL files and XML schema files and may generate an XML file, such as XML file 443 from the WSDL files and a subset of services cataloged in the XML schema files. The XML file 442 may be used to select and invoke services of the adaptor runtime component 422.

Suppose, in one embodiment of the invention, an SAP system requires server name, login, password, release number and version number to be passed to it in order to allow a connection to the SAP system. Similarly, the integration server 404 connecting to the SAP system needs to access a subset of the services provided by the SAP system. During design time, the adaptor for the SAP system may send the configuration user interface 410 XML schema 440. The user interface 410, here, acquires needed user input to allow for connection and access to the SAM system. Suppose the configuration user interface 410 generates the particular XML file 442 from the XML schema 440 and user input. During design time, the adapter for the SAP system may send the WSDL 446 describing adapter interfaces and associated service description XML files 447. The metadata utility 412 generates a user interface 444 from these WSDL and XML files. Suppose the metadata utility generates the particular XML file 443 from the WSDL and a subset of services cataloged in the XML files. The XML file 442 is used to configure the SAP system adapter runtime component 422 and the XML file 443 is used to select and invoke services of the SAP system adapter runtime component 422. The interface may be used to collect configuration information such as server name and IP address. This information is saved. When a user wants to access data from the SAP application, the user will use the saved configuration information to connect to the SAP application.

In one embodiment of the invention, in response to a query directed to the adaptor 420, the structure of the communication is returned. For example, in one embodiment of the invention, the metadata utility 412 receives a Web Services Description Language (WSDL) file from the design time/tools component 424 of adaptor 420. The Web Services Description Language is an XML-based language used to describe the services a business offers and to provide a way for individuals and other businesses to access those services electronically.

WSDL is derived from Microsoft's Simple Object Access Protocol (SOAP) and IBM's Network Accessible Service Specification Language (NASSL). WSDL is employed as the means of expressing business services in the Universal Description, Discovery, and Integration (UDDI) registry. The UDDI is an XML-based registry for businesses worldwide, which enables businesses to list themselves and their services on the Internet.

The metadata utility 412 may also receive an XML schema from the design time/tool component 424 of the adaptor 420. In some embodiments, the XML schema is part of the WSDL file received from the adaptor 420. The WSDL file received by the metadata utility 412 includes information concerning how the data will be send between adaptor and integration server. For example, the WSDL file may specify if the data is sent with tags, if it is send with tags, what kind of tags are used and so on.

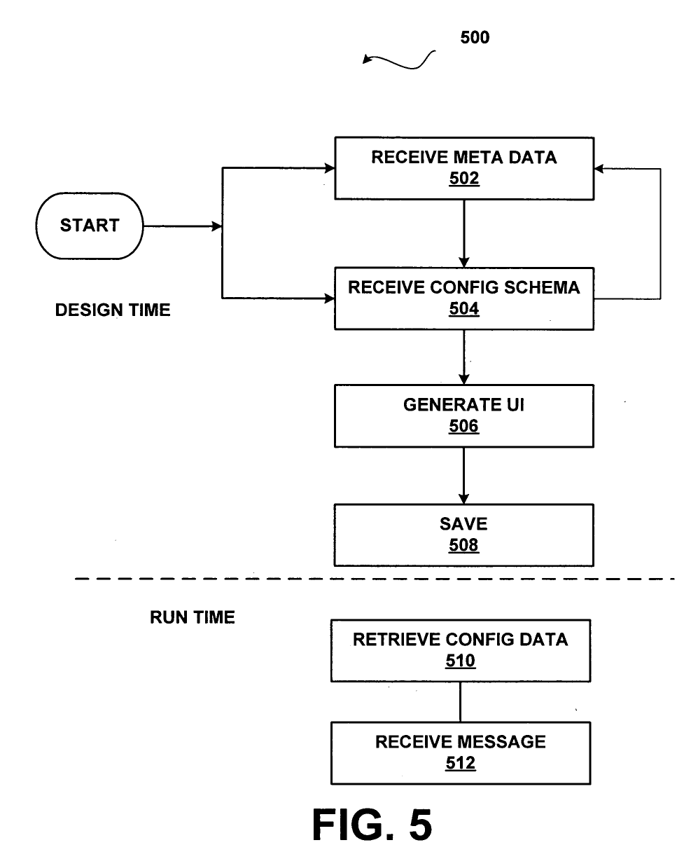

FIG. 5 is a method of providing a standardized adaptor framework in accordance with one embodiment of the invention.

An adapter associated with an application may include a deployment specification containing packages, binaries and instructions to set up the packages and binaries. The adapter may also include a configuration specification that describes the data that will be passed between the adaptor and the connector, including the nature of the information (properties) such as types, enumerations and dependences, required to get the adaptor connected and working with the application. When the adapter is installed, the deployment specification may be interpreted and appropriate components copied and registered as instructed in the specification. Information concerning the adapter may be stored in an adaptor registry.

At step 502, interaction information associated with the adaptor may be received from the adaptor by a metadata utility. The methods and events supported along with a description of the typical and allowed sequence of methods and events in order to accomplish an interaction is described in an interaction description using standards that describe the contracts between the systems. The adapter may pass its interaction specification in the form of WSDL and any message formats in the form of a message XML schema to the metadata utility. The utility may include a component that receives a WSDL file and creates therefrom an ODX file (a compiled form of the WSDL file). Runtime 406 may use the ODX file to determine which services and interfaces will be connected to. At step 504 configuration information associated with the adapter may be received. In some embodiments of the invention, configuration data for enumerating an adapter-specific configuration user interface is described in a configuration XML schema and is received by a configuration user interface module. The configuration XML schema includes in some embodiments of the invention, an endpoint configuration, representing a single string that includes all needed values to configure the adapter bound to the endpoint.

Alternatively, at step 506, an object may be dynamically generated from the configuration schema definition. In some embodiments, the object generated is a property page user interface at which additional information can be entered. The information may include instance data such as server name, IP address, login, password, version and so on. In some embodiments of the invention, the configuration interface translates the received configuration XML schema into code (e.g., C# code) from which an object is generated that encapsulates the fields described by the configuration XML schema and the data needed to configure the adapter. Only strings found in the configuration XML schema (field names, type names ad textual content) appear in the code in some embodiments. At step 508 the configuration data is saved. In some embodiments of the invention, the configuration data is captured in the form of an XML file and is stored in a configuration database, for use during run-time.

It will be understood the order of receiving metadata information or configuration information is not important; either metadata or configuration information can be received first.

The integration server selects the appropriate XML file from the XML file data store (510) and hands the XML file and the message to the adaptor. The adaptor receives the XML file and message and is able to connect to the desired application Once the methods and message types are described in the configuration interfaces, systems can send messages to the adapter. At 512 (during run-time) a message may be received at the integration server, indicating that a connection to an adaptor is requested.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Similarly it will be understood that although the test framework is described within the context of an automated way of testing software, the invention is not so limited and may be used wherever the scheduling of processes within a standardized format is useful, as for example in the context of business processes. Therefore, the present invention should not be limited to any single embodiment, but rather should be construed in breadth and scope in accordance with the appended claims.

1. A system for providing a standardized adaptor framework comprising:
a configuration user interface module for receiving a configuration schema describing configuration information;
a metadata utility for receiving at least one metadata file providing data interface information and service description information; and
generating from the configuration schema and the metadata file a configuration file and a service selection file required by an adaptor to connect to an application.

2. The system of claim 1, wherein the configuration schema comprises an XML schema.

3. The system of claim 1, wherein the at least one metadata file comprises a WSDL file.

4. The system of claim 1, wherein the at least one metadata file comprises an XML schema.

5. The system of claim 1, further comprising a data store for storing the configuration file.

6. The system of claim 1, further comprising a data store for storing the service selection file.

7. The system of claim 1, wherein the configuration file is an XML file.

8. The system of claim 1, wherein a unified user interface is generated from the configuration schema and the at least one metadata file.

9. The system of claim 8, wherein information entered via the unified user interface is stored in the configuration file.

10. The system of claim 8, wherein information entered via the unified user interface is stored in the service selection file.

11. The system of claim 2, wherein the XML schema is received from the adaptor associated with the configuration file.

12. The system of claim 1, wherein the at least one metadata file is received from the adaptor associated with the configuration file.

13. A method for providing a standardized adaptor framework, comprising:
receiving a description of configuration data associated with an adaptor;
generating an adaptor-specific user interface from the configuration data description:
receiving instance-specific data from the adaptor-specific user interface; and
saving the instance-specific data and the description of configuration data in an XML file.

14. The method of claim 13, further comprising:
saving the XML file in a data store.

15. The method of claim 13, wherein the description of configuration data is an XML schema.

16. The method of claim 13, further comprising receiving information associated with data interface and service description.

17. The method of claim 16, wherein the information associated with data interface and service description is a WSDL specification.

18. The method of claim 13, further comprising receiving a message associated with an application request.

19. The method of claim 14, further comprising receiving a message associated with an application request and selecting an XML file from the data store, the XML file associated with the application request.

20. The method of claim 19, further comprising sending the XML file to the adaptor.

21. A computer-readable medium comprising computer-executable instructions for:
receiving a description of configuration data associated with an adaptor;
generating an adaptor-specific property page from the configuration data description: and receiving instance-specific data from the property page.
